(19) United States
(12) Patent Application Publication
(10) Pub. No.: US 2010/0317418 A1
(43) Pub. Date: Dec. 16, 2010

(54) MAGNETIC DEVICE FOR THE SUPPORT, IN CARS, OF PORTABLE ELECTRONIC EQUIPMENT

(75) Inventor: Paolo Zanetti, Conegliano (IT)

Correspondence Address: EGBERT LAW OFFICES, 412 MAIN STREET, 7TH FLOOR, HOUSTON, TX, 77002, US

(73) Assignee: WALMEC Spa, Milano (IT)

(21) Appl. No.: 12/743,021

(22) PCT Filed: Nov. 13, 2008
(86) PCT No.: PCT/IB08/03224

§ 371 Date: Jul. 19, 2010

(30) Foreign Application Priority Data
Nov. 14, 2007 (IT) TV2007A000182

(51) Int. Cl. H04W 88/02

(52) U.S. Cl. 455/575.9

(57) ABSTRACT

A magnetic device for the support, particularly in cars, of portable electronic equipment includes a base that integrates at least two adjoining magnets, fixable on a surface internal to the driver and passenger compartment, and a coupling plate including ferromagnetic material fixable or integrated into the back of the equipment to support or on the intermediate accessory arranged for the support of the equipment. The base, having on one side a layer of material of adhesion to the surface of the driver and passenger compartment, is created through the coplanar approaching of at least two permanent magnets attracted to each other, each magnet having a polygonal plan geometric shape.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention refers to a magnetic device for the support, particularly in cars, of portable electronic equipment.

2. Description of Related Art Including Information Disclosed Under 37 CFR 1.97 and 37 CFR 1.98.

The mobile phone, as well as the navigator, is well-known, and even small electronic processors. It is a kind of portable equipment which is widely used, by now every day, and follows the user almost in all circumstances. When one is driving a motor vehicle, single regulations impose, at least in some countries, the use of such equipment in safety conditions, we will say with the universal term—hand free—, that is to say with free hands. According to this, for said requirements to subsist, the portable equipment should preferably be safely fastened to a support that, in principle, is firmly or temporarily fixed inside the driver and passenger compartment of the motor vehicle in a position as close to the driver as possible, e.g. the dashboard or the gear tunnel, in order to be easily accessible without causing particular distractions.

There are various kinds of supports for portable electronic equipment, if not originally provided by the car house. Traditionally, the most diffused originate from devices which have, on the fastening base, a sucker, which operated by a lever that cooperates with a cam, obtains a depression sufficient to hold the base of the sucker in the desired position. From the sucker base originates the support arm, at the end of which can be included different instruments for holding the electronic equipment, e.g. screw clamps, Velcro strips and others. Further empirical supports are usually created directly by the user, for example with the use of double-sided adhesive tapes or of Velcro, in order to secure, for example on the dashboard, a first layer of material to which the electronic equipment is fastened.

Permanent magnets are equally well-known. Widely used in the car industry as well, they are employed to fix, in a removable way, various equipment and accessories, mostly external to the driver and passenger compartment, e.g. the classic ski-carrier. The magnets are attracted or repelled by various materials. A material strongly attracted by a magnet has a high magnetic permeability, e.g. iron and steel, that are thus defined as ferromagnetic. There can be diverse magnets, for example Alnico magnets. They are produced through fusion or sintering. They react very well to high temperatures. They have a high remanence but the coercive force is rather low. Their shape is related to the low coercive force. Ferrite magnets are mainly produced through sintering. They are the most used because of their quality-price ratio. They are available in many qualities and have a good resistance to demagnetization. Neodymium or ND magnets are the best existing. They behave well according to temperatures. Finally, samarium-cobalt magnets, produced from elements of the families of rare earths, allow to reduce sizes, energy is high and they react rather well to high temperatures.

In some cases permanent magnets were used also inside the driver and passenger compartment, always as support means. One will remember, for example, when the dashboards of the driver and passenger compartment in a motor vehicle, instead of being made of plastic material, as they are now, were mostly made of metallic material, actually of the usual shaped metal plate. Being of ferromagnetic material, some accessories, above all gadgets and religious icons, had a magnetic tape on their back, mainly with the adhesive coupling interface, and shaped according to a square or even round geometric form. In this way, the gadget itself, attracted to the back because of the magnet, could be applied in the desired position.

In patent literature, there are some significant examples of application of a magnet for the support of equipment and accessories. 5E512358 (Gustaysson), for example, describes a shielded magnetic mobile phone stand, fixable to the computer, monitor or television, including a steel container that circumscribes multipolar magnets. The container of magnets is fixed to the computer, by means of glue or of double-sided adhesive tape.

Closer to the invention, instead, is KR200a10012021 (Ahn), in which is described a neodymium magnetic mobile phone stand, with a three-pole section. A magnetic mobile phone stand is intended to fix a mobile phone to the vehicle without damaging it and can be easily held with respect to knocks and children. It consists of an elastic surface of a sponge or rubber body intended to be fixed to a curved part. A highly elastic front plate is adherent to the front side of the elastic surface by means of an adhesive agent such as latex. An aromatic compound is contained in the elastic surface and a hollow is formed in the center to hold the magnet. A small bar containing iron is stuck to the mobile phone battery. Double-sided adhesive tape is added to the front face of the iron plate to attract the magnet. The used magnet has an upward or downward connection capacity or a three-pole section neodymium magnet, instead of a two-pole section magnet. The magnet with a three-pole magnetic field, has a broad magnetic field close to the pole because it has a uniform magnetic distribution. It does not affect inner electronic components.

U.S. Pat. No. 6,888,940 (Deppen) describes a magnetic stand for mobile telephones. It consists of a cup made of ferromagnetic material, inside of which a magnet is supported. The back part of the cup contains double-sided adhesive tape in order to provide the fastening of the cup to the surface of the vehicle dashboard. The cup concentrates the magnet force along the front edge. A friction ring circumscribes the front edges of the cup and provides an effective holding of the mobile phone fixed to the cup by means of the magnetic attraction between the inner magnet and the battery of the mobile phone or other metallic parts.

In W00049919 (Wemy), a magnetic coupling for various accessories and equipment is described. On the dashboard of a motor vehicle, by means of adhesive materials, is set a base made up of a magnet covered with rubber or neoprene, shaped in such a way as to peripherically give a rounded surface. Various accessories with support aims can be connected to the base, providing a counter-shaped seat on the base made of ferromagnetic material.

From everything stated above, it is therefore reasonable to consider as known:

a) the use of at least one magnet for the easily removable support of an electronic equipment or of a support accessory, e.g. the mobile phone, inside the driver and passenger compartment of a motor vehicle and in particular on the dashboard;

b) the magnet or the magnets according to the destination a) of multipolar kind that is to say with the three-pole geometry of the magnetic field with a central nucleus and two side poles;

c) the magnet integrated into a base with circular geometric shape intended to be set into a counter-shaped female seat obtained on the electronic equipment or support accessory to be fixed.

The above described solutions have, according to the applicant, some drawbacks. In particular, with reference to the solution SE512358 (Gustaysson), it can be observed that the magnets are not in direct contact with the accessory, but exploit a perimetrical container that constitutes an induced attraction surface, that could alter the effectiveness of the magnet action with consequent accidental detachment of the equipment.

As regards KR200a10012021 (Ahn), the solution of multipolar magnets, seems to be effectively suitable for a good fastening of the accessory or of the equipment, however, consisting of a magnet of monolithic construction, it needs a sufficient flat space and significant sizes which today are difficult to be found in the conventional internal design of cars.

The solution proposed in U.S. Pat. No. 6,888,940 (Deppen) is basically very similar to SE512358 (Gustaysson), therefore it is reasonable to hypothesize problems similar to the latter.

Finally, as for W00049919 (Wemy) it was observed that it combines the action of the magnet, which is fixed on the dashboard of the motor vehicle, with a housing seat obtained in the equipment or on the intermediate support accessory of the latter, a solution that seemingly could improve holding effectiveness. However, it seems reasonable to suppose that the use of a conventional monolithic magnet does not grant a good holding capacity of the accessory at all, and this also considering that sometimes the equipment may have a certain weight, which requires a correct proportional increase in the magnet sizes. The latter disadvantage, that can easily concern other solutions as well, which were mentioned before, implies the need to have rather wide and sufficiently flat surfaces for an effective adherence of the adhesive to which the magnetic system is fixed. The evolution—both aesthetic and technological—in the production of motor vehicles is actually leading to an unavailability of surfaces with such features, with an availability of only small spaces increasingly obtained with curved surfaces. Moreover, the devices provided by known technology, owing to their size, not only determine an increase in the production costs of the support device, but also negatively affect the aesthetic profile, making the installation of the device inside the driver and passenger compartment not very agreeable to the user, as very visible, besides significantly increasing the weight and size of the cellular equipment, when needing to apply either a ferromagnetic part or the magnet on the device.

Considering all this, the enterprises of the sector need to find innovative solutions which can overcome at least the above mentioned problems.

### BRIEF SUMMARY OF THE INVENTION

These and other aims are achieved by the present innovation according to the features described in the annexed claims, solving the expounded problems by means of a magnetic device for the support, particularly in cars, of portable electronic equipment, including a base that integrates at least two adjoining magnets, fixable on a surface internal to the driver and passenger compartment, and a coupling plate including ferromagnetic material fixable or integrated into the back of the equipment to support or on the intermediate accessory arranged for the support of the equipment in which the base, having on one side a layer of material of adhesion to the surface of the driver and passenger compartment, is created through the coplanar approaching of at least two permanent magnets attracted to each other, each magnet with a polygonal plan geometric shape. The base coupling plate, that includes at least one part made of ferromagnetic material, is of the kind with the interface of coupling to the equipment provided with a layer of double-sided adhesive material, whereas the face attracted by the magnetic field of the base is of the suitable size to self-center on the magnets it must be fixed to, due to the arrangement of the magnetic fields to which it is subject.

In this way, through this considerable creative contribution whose effect represents an immediate and significant technical improvement, diverse and important aims are achieved.

A first aim was to obtain a magnetic device for the support of electronic equipment, which would make the action of connection and detachment of the equipment from the support, self-centering, much more precise than that usually obtainable from the use of the described solutions. This was made possible by the adopted solution given by the adjoining magnets, where the symmetry center and the concentration of the lines of force of the magnetic field in the perimeter of the magnets, which make up the system, coincide with the center of the surface of total attraction of the base. In this way, the user's hand is further driven by the multipolar magnetic field, and induced to correctly position the insert that is connected to the equipment. KR200a10012021 (Ahn) seemingly solves the problem in the same way, however in the latter the magnet is monolithic. This implies the disadvantage that the multipolar magnetization in the magnet cannot achieve the concentration of the magnetic flux in the magnets' perimetrical areas as in the composition with adjoining single magnets. In other words, it does not allow a practical, effective and compact fastening, adaptable to curved surfaces and aesthetically not very bulky, as the object of this invention.

A second aim was to realize a magnetic base, which could better adapt to the irregular surfaces and curves of the driver and passenger compartment, e.g. the dashboard. In fact, differently from KR200a10012021 (Ahn) that consists of a single magnet, or from U.S. Pat. No. 6,888,940 (Deppen) and 5E512358 (Gustaysson) which do include more magnets, yet the magnets are integrated into a container and therefore are moved away from the adhesion surface that is made up—by means of the bottom—of a single flat surface, the solution object of this invention, as it is composed by the approaching of at least three magnets supported by a flexible double-sided adhesive tape, can be adapted in an optimal way to all surfaces, even slightly curved or rough, allowing a certain clearance tolerance among the magnets themselves without substantially altering the female configuration of the base.

A third aim is to reduce the aesthetic impact, limiting altogether the costs of production and of stock management of the product.

In conclusion, the significant value of these advantages is to achieve a good technological content.

These and other advantages will emerge from the following detailed description of a preferred solution with the aid of the enclosed schematic drawings, whose execution details are not to be considered as limitative but only and exclusively as illustrative.

BRIEF DESCRIPTION OF THE SEVERAL VIEWS OF THE DRAWINGS

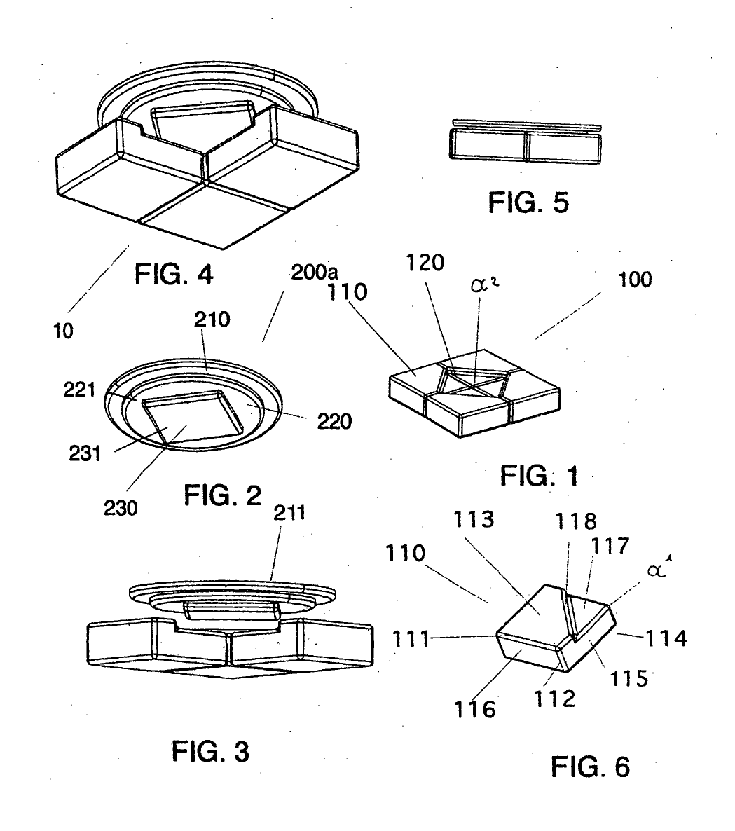

FIG. 1 is a perspective view of the base obtained from the approaching of four magnets;

FIG. 2 is a lower perspective view of the base coupling plate of FIG. 1;

FIG. 3 is a schematic view of the magnetic device for the support of a portable equipment in phase of coupling;

FIG. 4 is a schematic view from the bottom of the magnetic support device of FIG. 3;

FIG. 5 is a side and whole view of the coupled magnetic support device of FIGS. 3 and 4;

FIG. 6 is an upper perspective view of one of the four symmetric magnets that form the base of FIG. 1;

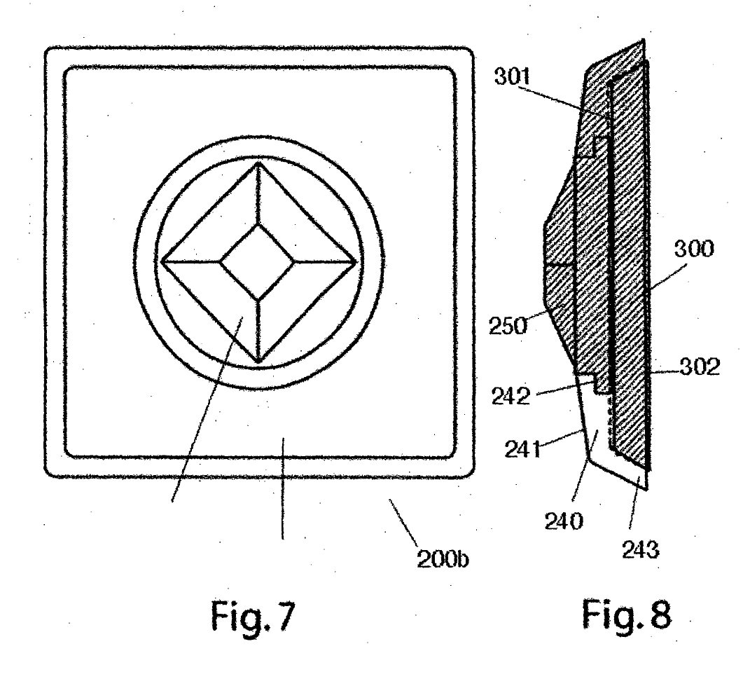

FIG. 7 is a plan view of a second solution concerning only the coupling plate which supports a ferromagnetic insert.

FIG. 8 is a cross-sectional view of the coupling plate of FIG. 7.

### DETAILED DESCRIPTION OF THE INVENTION

The present innovation refers to a magnetic device 10 (FIG. 4) for the support, particularly in a car, of portable electronic equipment.

The magnetic device 10 for the support, particularly in a car, of portable electronic equipment is basically subdivided into two parts, respectively a base 100 (FIG. 1) and a coupling plate 200a (FIG. 2) or 200b (FIG. 7) that is attracted by the base 100.

The base 100 is obtained by drawing close to one another at least two axially magnetized magnets 110—inverted polarity, in an application example four symmetric ND (neodymium) magnets 110 with magnetizing degree N50 (FIG. 1). Each magnet 110 (FIG. 6) has parallelepiped shape with a square plan geometric design with beveled horizontal edges 111 and vertical edges 112. Every magnet 110 has an upper face 113 and a lower face 114 peripherically defined by first walls 115 and second walls 116. More particularly, the upper face 113 constitutes the main attraction side, while the lower face 114 constitutes the side of connection to a layer of support material, not shown, e.g. double-sided adhesive tape. In one of the possible configurations, the upper face 113 has, on one of its four corners, a lowered plane 117, with a step 118 which obliquely cuts the upper face 113.

Drawing close to one another, to form the base 100, the magnets 110 with the lowered planes 117 contiguous, a lowered seat 120, female, is obtained.

As for the coupling plate 200a, (FIG. 2) it has circular plan and has a male insert. It includes a bottom 210 whose face, turned towards the exterior of the device 10, is flat and with double-sided adhesive material 211. Concentrically inscribed with reference to the bottom 210, opposite the face 211 is a first raised plane 220 with circular plan and of ferromagnetic material, peripherically defined by a step 221, thus obtaining a contact surface with reference to the attraction surface of the base 100 peripheral to the lowered seat 120. Inside the area of the raised plane 220 is obtained a protruding second raised plane that constitutes the male insert portion 230, of ferromagnetic material counter-shaped compared to the lowered attraction seat 120 of the base 100, therefore with quadrilateral plan and with beveled guided-introduction edges 231.

The support device 10 in the version depicted in FIGS. 7 and 8 presents a second hypothesis of coupling plate 200b to the corresponding base 100. The coupling plate 200b includes a shell-like cover 240, made of plastic material which is of over-injected type with respect to the insert 250, centrally positioned, that is of ferromagnetic material. In this case the insert 250 protrudes with reference to the external face 241 of the cover 240 with a configuration that is counter-shaped compared to the lowered attraction seat 120 of the base 100. As for the conformation of the cover 240, it can be observed that it internally has a holding area, including a peripheral tooth 242 which does not allow the extraction of the insert 250 of ferromagnetic material. Furthermore, it can be observed that the cover 240 on the face of connection to the object to support opposite the external face 241, perimetrically has a divergent wall 243 with an edge function, so as to create a wide housing. Inside the housing outlined by the wall 243 is included a layer of double-sided adhesive material 300 whose thickness is greater than the depth of the housing in order to protrude with the visible external face 302 from the edge of the wall 243. The adhesiving interface 301 firmly connects the layer of double-sided adhesive material 300 to the cover 240 which holds the insert 250 and to the insert 250 itself, whereas the external face 302 provided with removable anti-adherent film, can facilitate the fastening of the coupling plate 200b to the object to support, as it can be adapted in an optimal way to the surface shape.

Finally, in another version it can be observed that the insert of ferromagnetic material 230, 250 can be directly integrated into the back of plastic material of the electronic equipment to support.

The support device 10 achieves its function laying the coupling plate 200a or 200b, that is connected by means of the face 211, 302 to the equipment to support, upon the adhesived base 100 on the surface of the driver and passenger compartment, so that, due to attraction, the second raised plane or insert 230, 250 of the coupling plate 200a, 200b, coincides and enters—because of the reciprocal attraction—the lowered attraction seat 120 of the base 100, at the same time placing the attracted surface of the first raised plane 210 or external face 241 of the cover 240 attracted in contact with the surface of the base 100, surrounding the lowered attraction seat 120.

1. Magnetic device for the support, in cars, of portable electronic equipment, including a base that integrates at least one magnet, fixable on an internal surface of the driver and passenger compartment, and a coupling plate that includes ferromagnetic material associable to the back of the equipment to support or on the intermediate accessory arranged for the support of the equipment, characterised in that the base, which on one side is provided with a layer of material of adhesion to the surface of the driver and passenger compartment, is female and is created through the coplanar approaching of at least two permanent magnets reciprocally attracted to one another, shaped in such a way that, drawn close to one another, they make a lowered attraction seat, and in which the coupling plate to the base includes at least one male portion or insert counter-shaped compared to the lowered attraction seat.

2. Magnetic device according to claim 1, characterised in that the coupling plate has a coupling interface to the equipment provided with a layer of double-sided adhesive material.

3. Magnetic device according to claim 1, characterised in that the magnets are of the axially magnetized type—inverted polarity.

4. Magnetic device according to claim 1, characterised in that the coupling plate includes a shell-like cover of plastic material over-injected with respect to the ferromagnetic insert, protruding from an external face of the cover with a structure that is counter-shaped compared to the lowered attraction seat of the base.

5. Magnetic device according to claim 4, characterised in that the cover has a holding area on the inner side, including a peripheral tooth and which, on the face of connection to the object to support opposite the external face, is peripherically provided with a wall that outlines a housing inside of which is contained a layer of double-sided adhesive material whose thickness is greater than the depth of the housing in order to protrude with the visible external face from the edge of the wall.

6. Magnetic device according to claim 4, characterised in that an adhesiving interface firmly connects the layer of double-sided adhesive material to the cover that holds the insert and to the insert itself, whereas the external face provided with removable anti-adherent film, is intended to facilitate the fastening of the coupling plate to the object to support.

7. Magnetic device according to claim 2, characterised in that each magnet of the base has a lowered plane congruous and symmetrical to at least a second lowered plane of corresponding magnets drawn close to one another, in order to obtain a lowered attraction seat and in which the coupling plate to the base that includes at least one male insert portion counter-shaped to the lowered attraction seat obtained in the base made of ferromagnetic material is of the type with the coupling interface to the equipment provided with a layer of double-sided adhesive material.

8. Magnetic device according to claim 1, characterised in that each magnet, has parallelepiped shape with a square plan geometric design and with beveled horizontal edges and vertical edges, every magnet has an upper face and a lower face peripherically outlined by first walls and second walls, in which the upper face constitutes the main attraction side, whereas the lower face constitutes the side of connection to a layer of support material, double-sided adhesive; the upper face includes, on one of its four corners, a lowered plane, in order to obtain a step that obliquely cuts the upper face with reference to the walls and in which the ends of the step join the walls.

9. Magnetic device according to claim 1 characterised in that the base includes at least two magnets with the first and second lowered planes contiguous, so that they are radial, one next to the other, obtaining a lowered seat peripherically defined by as many steps, one for each magnet, arranged in such a way as to be perpendicular to one another.

10. Magnetic device according to claim 1, characterised in that the coupling plate has circular plan, and includes a bottom whose face, turned towards the exterior of the device, is flat and with adhesive material, with concentrically inscribed with reference to the bottom, opposite the face, a first raised plane with circular plan and of ferromagnetic material, peripherically outlined by a step, obtaining a contact surface with respect to the attraction surface of the base peripheral to the lowered seat and with, inside the area of the raised plane, protruding, a second raised plane male insert portion, of ferromagnetic material counter-shaped compared to the lowered seat of the base, with quadrilateral plan and with rounded guided-introduction edges.

11. Magnetic device according to claim 1, characterised in that the insert of ferromagnetic material is directly integrated into the back of plastic material of the electronic equipment to support.
